(19) United States
(12) Patent Application Publication
(10) Pub. No.: US 2017/0249345 A1
(43) Pub. Date: Aug. 31, 2017

(54) A BIOMOLECULE BASED DATA STORAGE SYSTEM

(71) Applicants: Girik Malik, New Delhi (IN); Pawan K. Dhar, Greater Noida (IN)

(72) Inventors: Girik Malik, New Delhi (IN); Pawan K. Dhar, Greater Noida (IN)

(21) Appl. No.: 15/519,841

(22) PCT Filed: Oct. 16, 2015
(86) PCT No.: PCT/IB2015/057964

§ 371 Date: Apr. 18, 2017

(30) Foreign Application Priority Data
Oct. 18, 2014 (IN) 2975/DEL/2014

(51) Int. Cl. G06F 17/30; G06F 19/26; G06F 19/28; G06F 19/22

(52) U.S. Cl. CPC G06F 17/30345; G06F 19/22; G06F 19/26; G06F 19/28; G06F 17/30082

(57) ABSTRACT

The present invention describes a biomolecule based storage system for converting, storing the data in DNA coded form and retrieving data using pointer file approach. User input data is converted into 4base DNA sequence, called Nibble, which is further mapped onto the DNA sequence of an organism. The first position of each converted nibble is then obtained and stored in a pointer file. By mapping the positions of pointer file onto the DNA sequence of the organism, the data can be retrieved.

### FIELD OF INVENTION

The present invention relates to data storage system, particularly storing data in a naturally occurring or synthetically created biomolecule such as but not limited to Deoxyribonucleic acid (DNA), Ribonucleic acid (RNA), proteins, primary metabolites, secondary metabolites, their complexes and other combinations.

### BACKGROUND OF THE INVENTION

Computer data is continuously growing in terms of size, format and complexity. The conventional storage media such as magnetic storage media, optical storage media, etc. typically used for archival storage gradually lose their coating and become brittle over time. The conventional methods of storing digital information for prolonged periods continue to pose problem. Therefore, there existed a need of an extremely compact storage media having massive storage capability for long time.

The DNA based storage system came into existence as DNA can be stored for a longer period of time with almost no maintenance cost. DNA remains stable over time and if is refrigerated or frozen, the stability is even longer. The DNA based storage system safely stores digital data for thousands of years and requires less space. The four nucleobases, cytosine, guanine, adenine and thymine, abbreviated as C, G, A and T present in the double helix architecture of DNA correspond to the binary language used in digital technology. The information storage density of DNA is at least a thousand times greater than that of existing media.

Indian Patent Application 3822/DELNP/2005 discloses a method for storing information in DNA which includes software and a set of schemes to encrypt, store and decrypt information in terms of DNA bases. First of all, information is encrypted along with carefully designed sequences known as header and tail primers at both the ends of actual encrypted information. This encrypted sequence is then synthesized and mixed up with the enormous complex denatured DNA strands of genomic DNA of human or other organism.

Goldman et al. (Nature 494, 77-80 (7 Feb. 2013) describes a scalable method where DNA is used as a target for readily storing information. Computer files totalling 739 kilobytes of hard-disk storage was encoded and with an estimated Shannon information of 5.2×10̂6 bits into a DNA code, the DNA was synthesized, sequenced and the original files were reconstructed with 100% accuracy. Goldman's technique works by providing redundant overlapping of DNA sequence as to combat with the loss of sequences due to machine's inaccuracy. Also they encode it to base3 first and then to DNA; they use a 5 base sequence for the conversion.

Currently, most of the DNA based data storage techniques use physical DNA that involves synthesis and sequencing of DNA. The cost of DNA synthesis and sequencing is too expensive for these techniques to work on a routine basis. To overcome this limitation, the present invention uses only a computational DNA sequence and not the physically synthesized and sequenced DNA strands. Further, the present invention discloses a pointer file that provides position of the Nibble in the DNA sequence to convert the data in the DNA (Deoxyribonucleic acid) Coded form. The advantage with the pointer file is using only DNA sequence of an organism and eliminating DNA synthesis.

Most of the current storage platforms are not scalable due to immense demand on the space, cost and energy involved in maintaining big data servers. The pointer-based data storage provides more robust data storage and retrieving all the data based on pointer file even if the mapping sequence is lost.

### OBJECT OF THE INVENTION

The primary object of the present invention is to provide a data storage system for converting and storing the any type of data including text, image, audio, video, etc. in DNA coded form.

Another object of the present invention is to provide a pointer file for retrieval of data.

Yet another object of the present invention is to provide a pointer file which is used to retrieve the data even in case of a complete wipe out of both Data and DNA sequence.

Yet another object of the present invention is to provide a pointer file using which the position to any of the pages/index could be mapped directly.

Another object of the present invention is to provide a pointer file that stores only first position of converted DNA sequence on DNA sequence of an organism, hence uses far lesser DNA sequence (than what is available naturally) thereby reducing the disk space used for data storage.

Another object of the present invention is to use only computational DNA sequence thereby eliminating the need of physically synthesized and sequenced DNA and reducing the cost involved in these physical processes.

Another object of the present invention is to provide a system where the data is completely encrypted and secured.

### SUMMARY OF THE INVENTION

The biomolecule based data storage system comprising conversion and storage of data into DNA coded form uses a pointer file approach for retrieving data from DNA coded form.

In the present invention, the user input is converted to 4-base DNA sequence, called a Nibble with the use of ASCII map which contains all the 256 ASCII characters and the corresponding 256 possible combinations of the four bases of DNA, namely, A, G, C and T. For all 256 possible combinations of DNA sequences, 256 files with the same name as the Nibble are created which are mapped to the DNA sequence of E.coli (E.coli's Master DNA file) and their respective positions on the physical DNA sequence of E.coli are obtained in the format [start position,end position]. These positions are recorded in a file, called pointer file.

The first position of each Nibble obtained from the respective pointer files is stored in another pointer file. Hence, the first positions of all the Nibbles converted from data (user input) is obtained and stored in said pointer file which is used to retrieve the complete data by mapping onto the DNA sequence of E.coli. By reading the DNA sequence and loading the pointer file, it is possible to retrieve the original document.

Using the pointer file approach, the data is stored only in less than 25% of physical DNA of E.coli as the pointer file takes only the first position of the DNA sequence even if the same DNA sequence occurs more than once.

### BRIEF DESCRIPTION OF DRAWINGS

The present invention may be better understood and its methodology, objects, features and advantages are made apparent to those skilled in the art by referring to the accompanying drawings.

FIG. 1 represents the process of conversion of data to DNA and pointer.

FIG. 2 represents the virtual DNA shuffle keyboard.

### DETAILED DESCRIPTION OF INVENTION

The following detailed description is merely exemplary in nature and is not intended to limit the invention or the application and uses of the invention. The detailed description is construed as a description of the currently preferred embodiment of the present invention and does not represent the only form in which the present invention may be practiced. This is to be understood that the same or equivalent functions may be accomplished, in any order unless expressly and necessarily limited to a particular order, by different embodiments that are intended to be encompassed within the scope of the present invention.

The embodiment is chosen and described to provide the best illustration of the principles of the invention and its practical application, and to enable one of ordinary skill in the art to utilize the invention in various embodiments and with various modifications as are suited to the particular use contemplated.

Furthermore there is no intention to be bound by any expressed or implied theory presented in the preceding technical field, background, brief summary or the following detailed description. It is further understood that the relational terms such as first, second etc., if any, are used solely to distinguish one from another entity, item or action without necessarily requiring or implying any actual such relationship or order between such entities, items or actions.

The present invention takes into consideration the 256 possible combinations of the four bases of DNA, namely A, G, C & T as the American Standard Code for Information Interchange (ASCII) table contains 256 possible combinations of character and their corresponding encoding in decimal. Therefore, with a set of four bases, complete extended ASCII set (256 in numbers) has been encoded as the possible combinations with 4 bases is 4̂4=256.

The methodology of the present system is demonstrated on ASCII table's decimal encoding (i.e., base 10), but is not limited to the decimal number system and can be extended to other number systems like binary, hexadecimal, octal and other numeral base systems.

The ASCII Map contains the possible DNA sequences constructed using four bases (256 in number) in one row and the corresponding characters (Uppercase & Lowercase English alphabets, special characters, numbers, tabs, new lines, carriage return, etc.). Other characters of scripts such as Devanagari, Bengali, Spanish, Italian, French, German, Portuguese, Polish, etc. can also be mapped with DNA sequence using the methodology of present invention.

For 256 possible combinations of DNA sequences, 256 files with the same name as the Nibble are created. These files are named as <DNA sequence>.csv, where <DNA sequences>are the 256 possible combinations of the DNA, i.e. AGCT, GACT, AAAT, etc.

The present invention converts data (user input characters) to a set of 4-base DNA sequences (AAAA, AAGT, AACT, etc.) called Nibble (named after 4 bits in the physical computer memory) with the help of an ASCII Map. The 4-base long Nibble allows repetition of bases, like AAAA, AAGT, AACT, AATT, TTAC, etc.

The present invention maps the data onto the DNA sequence of any prokaryotic or eukaryotic organism. In the most preferred embodiment, the present invention, described as the pointer approach, maps the data onto the DNA sequence of Escherichia coli (E.coli).

All the possible 256 Nibble combinations occur in less than first 25% of the physical DNA of E.coli. Therefore, less than 25% of physical DNA of E.coli can be used to convert, store and retrieve data. Further, even if the organism is changed in every case, far lesser DNA sequence is used (than what is available naturally) for data storage.

All 256 possible Nibble combinations, as created above, are mapped to the DNA sequence of E.coli (E.coli's Master DNA file) and their respective positions on the DNA sequence of E.coli are obtained in the format [start position,end position]. These positions are recorded in a file, called pointer file, named as <Nibble sequence>.csv. For example: AAAT.csv will contain the start, end positions of all the AAAT in the DNA of the E.coli. For instance if the DNA sequence of E.coli is AAATTGCGGTACGTAGAAATCAGTTCAAGTCA, then AAAT.csv will contain 1,4 and 17,21 (in the newline).

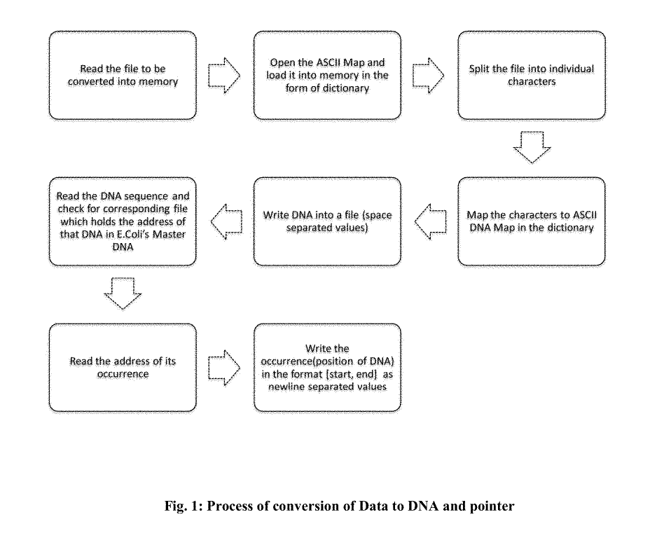

FIG. 1 shows the methodology for conversion of data to DNA and pointer wherein the document to be converted is taken as an input from the user, opened and read into memory. The ASCII Map is opened and a dictionary is created which contains key-value pairs where the key is the character and the value is DNA sequence. The method for creating a dictionary is that most occurring character (for example, vowel) is mapped to the most frequent DNA sequence of E.coli. The user given document is split into individual characters and stored into a structured format, such as an array (array 1). Other structured format can also be used such as stack, graph, tree, queue, link list, hash map, list, vector, dictionary, union, set, etc. for storing information. Each character in the array (array 1) is taken one by one and the DNA sequence for that character given in the dictionary is checked. So the character is taken as the key and its value is taken from the dictionary. In this way, all the characters from the array (array 1) are mapped to the ASCII Map and their corresponding sequences are obtained. The DNA sequence obtained for the first character is stored in another array (array 2) and DNA sequence for each subsequent character is appended to the previously obtained DNA sequence. The array (array 2) is then written in a file, referred to here as DNA sequence file, with each Nibble (DNA sequence) separated by a space. The DNA sequence is read and the corresponding file which holds the position of that DNA sequence in E.coli's Master DNA file is opened and the first position of its occurrence (in the same start, end format) is picked up and stored into another array (array 3). In this way, each DNA sequence is picked up one by one, the corresponding file is opened and the first position of its occurrence is picked up and stored into array (array 3).

The array (array 3) containing the positions of the DNA sequence on E.coli's Master DNA is then written into a new file (pointer file), separated by new lines. The pointer file is then stored and can be used to retrieve the complete data by mapping onto the DNA sequence of E.coli. By reading the DNA sequence and loading the pointer file, it is possible to retrieve the original document.

Using the pointer file, the position to any of the pages/index could be mapped directly which is not present in the conventional methods. That is, with the pointer approach, we can map the specific location (for example particular page of a document) as well and hence go to that specific location.

The present invention converts data to a set of 4-base DNA sequences, which can be traced back to the data only with the help of ASCII Map, hence the technique is suitable for storing passwords and other classified and confidential information and documents, which can be read only after converting DNA sequence back to Data.

The DNA sequence file is itself encoded and can be used to produce a physical DNA which can be readily used or can be stored for longer duration and serve as a data warehousing solution. Another use of it can be in terms of the virtual sequence, which can be stored as encrypted data, suitable for password, data security, classified information, etc.

The data as converted to DNA sequence and a pointer file, provides solutions for massive and long-term data storage, retrieval, encryption, data security, password, classified information, etc.

The pointer file provides a more robust solution for prevention of Data Loss. It can be maintained as a backup of all the converted data. In case of a complete wipe out of both Data and DNA sequence, the pointer file can be fed to a pointer head and can be used to retrieve the complete data. The positions can then be mapped from pointer file to the corresponding physical position in the DNA sequence and the respective Nibbles can be read, which can then be converted back to data, using the ASCII Map.

Using the pointer file approach, the data is stored only in less than 25% of physical DNA of E.coli as the pointer file takes only the first position of the DNA sequence even if the same DNA sequence occurs more than once. Therefore, no matter how big the data is, it will be mapped in less than 25% of DNA sequence of E.coli. The pointer file approach used in the present invention leads to reduction of disc space used for data storage. The technique can be used to convert almost all forms of Data into DNA and pointer, which can be mapped to less than 25% of the physical DNA.

In the pointer file approach of the present invention the cost of physical DNA synthesis and sequencing is eliminated and only DNA sequence is used for data conversion, storage and retrieval. The other advantage of using the pointer approach is to be able to pinpoint the location of different files and identify them uniquely.

The data (user input) can be converted to DNA sequences as well as to protein sequences. In other embodiment, the DNA sequences are fed into another program/module of the program which converts/translates the DNA sequence to protein sequence.

The protein sequences (20 in number) are written in top row and first column and a matrix is created that contains combinations of both the row and column, the matrix comes out to be 20×20 (400 elements). These elements are arranged in a list where first 256 sequences are picked up. In this embodiment, the 256 sequences are selected row wise and all the protein sequences are sorted to be arranged alphabetically.

The list so obtained is used to construct the protein map. The 256 sequences can also be picked up in a random or pseudo-random manner according to a key which can be used to create a different cipher with different keys, wherein the keys could be based on, but not limited to, some alpha-numeric combinations, time, date, etc.

The protein map is loaded into a dictionary (containing the 4 bases 256 DNA sequences, i.e. Nibble) in the form of key-value pairs, where keys are the Nibble and values are the proteins. The key-value pairs are made in such a way that if a key is called, it returns the value associated with it. For example: if the pair is AAAT:CA, where AAAT is the key (Nibble) and CA is the value (protein sequence), calling AAAT returns CA.

First the DNA sequence file is obtained in the same manner as stated above in the first embodiment. The ‘DNA sequence file’ (containing 4 base DNA sequences (Nibble) in a space separated manner) is opened and stored in an array (array 4). The

Nibble is taken one by one from array 4 and checked for its value in the dictionary, the corresponding value returned is stored in the same order in another array (array 5), which will hold all the protein sequences.

The array holding the protein sequence is then written onto a file, referred to as the protein file, where the sequences are of length two each, separated by a space.

The Nibble of respective protein sequence can be retrieved by using the dictionary containing protein sequence and corresponding Nibble and thereafter the original data can be obtained by using dictionary containing Nibble and their corresponding characters. The original data can also be retrieved by using pointer file as stated in the first embodiment of the invention.

In other embodiment, the data can be directly converted to protein sequences by mapping the data to protein using protein map.

After the complete document is converted to protein sequence, it is stored and can be used to retrieve the complete data by either converting protein sequence to DNA sequence or to data directly.

The conversion of data to protein sequence provides more credibility as the virtual sequences generated are also reduced in terms of virtual disk storage.

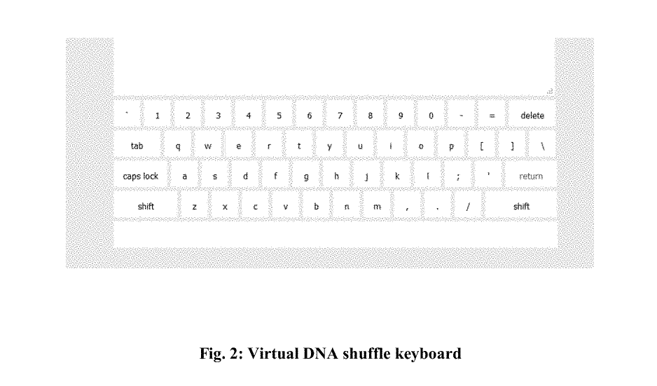

The aforementioned methodology can be used for a virtual DNA shuffle keyboard (FIG. 2) which can be integrated with the secure access networks for entering the passwords and other information. It works on the method of writing DNA bases instead of normal characters according to the mapping.

The applications of the present invention include, but not limited to, Massive/Big Data Storage, Password Storage, Cryptography, Secure Data Storage, Secret File storage, Data Archival, Data Warehousing, DNA based on-screen Keyboard, DNA based on-screen shuffle Keyboard, Protein based on-screen Keyboard, Protein based on-screen shuffle Keyboard, Banking Information/Data Storage, Data Compression.

In addition, to generating unique data storage solution, we have also developed a novel approach of encrypting data to store passwords. For example, the work in the field of cryptography can be extended by designing special algorithms for password storage, in both DNA and protein molecules.

The invention is defined by the appended claims including any amendments made during the pendency of this application and all equivalents of those claims as issued. Moreover, numerous modifications and variations can be made according to requirements by a technical expert in the sector to the invention as described in the foregoing, without forsaking the scope of the invention as claimed in the following.

We claim:

1) A biomolecule based data storage system, comprising:
an E.coli Master DNA file, said file containing physical DNA sequence of E.coli;
an ASCII map having 256 characters and 256 combinations of 4-base DNA sequence, said 4-base combination is called a Nibble;
creating a dictionary having each said Nibble paired up with its corresponding character;
mapping each said Nibble with the DNA sequence of E.coli;
obtaining all the positions of each Nibble on said DNA sequence of E.coli;
wherein a pointer file is created for each Nibble, each said pointer file stores all the said positions of respective Nibble;
reading input data and storing each character of said data in first structured format;
taking each said character of input data to search for the corresponding Nibble in said dictionary;
storing said searched corresponding Nibbles in second structured format;
creating a file of second structured format containing said searched Nibbles;
wherein each Nibble from said file of second structured format is taken to search for the corresponding pointer file;
wherein the said pointer file containing positions of respective Nibble is opened and first position of each said Nibble is obtained;
wherein, said obtained first positions are stored in a third structured format;
wherein a pointer file of third structured format is created and stored;
wherein using the pointer file, complete data can be retrieved by mapping the positions of the Nibble onto the DNA sequence of E.coli;
wherein using the pointer file the position to any of the pages/index could be mapped directly.

2) The biomolecule based data storage system as claimed in claim 1, wherein the biomolecule is naturally occurring or synthetically created Deoxyribonucleic acid (DNA), Ribonucleic acid (RNA), proteins, primary metabolites, secondary metabolites, their complexes and other combinations.

3) The biomolecule based data storage system as claimed in claim 2, wherein said biomolecule is of any prokaryotic or eukaryotic organisms.

4) The biomolecule based data storage system as claimed in claim 1, wherein the said input data is text, photos, videos, audio, etc.

5) The biomolecule based data storage system as claimed in claim 1, wherein the said characters are uppercase and lowercase English alphabets, special characters, numbers, tabs, new lines, carriage return and other characters of scripts such as, but not limited to, Devanagari, Bengali, Spanish, Chinese, Japanese, Italian, French, German, Portuguese, Polish, etc.

6) The biomolecule based data storage system as claimed in claim 1, the said structured format is an array, stack, graph, tree, queue, link list, hash map, list, vector, dictionary, union, set and other format.

7) The biomolecule based data storage system as claimed in claim 1, wherein the said data is converted by using any of the decimal number system, binary, hexadecimal, octal and other numeral base systems.

8) The biomolecule based data storage system as claimed in claim 1, wherein said 256 combinations of 4-base DNA occur in less than 25% of physical DNA of E.coli.

9) The biomolecule based data storage system as claimed in claims 1 and 7, wherein owing to the storage of only the first position of each nibble in the pointer file, the data is stored in less than 25% of physical DNA of E.coli.

10) The biomolecule based data storage system as claimed in claim 1, wherein said data can be directly encrypted to protein sequences.

11) The biomolecule based data storage system as claimed in claim 1, wherein said system uses only computational DNA and eliminates the need of physically synthesized and sequenced DNA.

12) The biomolecule based data storage system as claimed in claim 1, wherein the said system can be also used for a virtual DNA shuffle keyboard which is integrated with the secure access networks for entering the input data and other information and writes DNA bases instead of normal characters according to the mapping.
